(19) United States
(12) Patent Application Publication
(10) Pub. No.: US 2018/0032087 A1
(43) Pub. Date: Feb. 1, 2018

(54) DRONE WITH AN OBSTACLE AVOIDING SYSTEM

(71) Applicant: PARROT DRONES, Paris (FR)

(72) Inventor: Martin LINÉ, Paris (FR)

(21) Appl. No.: 15/662,163

(22) Filed: Jul. 27, 2017

(30) Foreign Application Priority Data
Jul. 27, 2016 (FR) 1657200

(51) Int. Cl. G05D 1/08; B64C 39/02; G08G 5/04; G05D 1/00

(52) U.S. Cl. CPC G05D 1/0808; G05D 1/0094; B64C 39/024; G08G 5/04; B64C 2201/127; B64C 2201/024; B64C 2201/141

(57) ABSTRACT

A rotary-wing drone includes a drone body including an electronic card controlling the piloting of the drone and one or more linking arms, one or more propulsion units mounted on respective ones of the linking arms, and at least one obstacle sensor integral with the drone body, whose main direction of detection is located in a substantially horizontal plane. The drone additionally includes logic executing by a processor in the electronic card and adapted to perform the controlling by correcting the drone orientation—specifically the yaw orientation—of the drone in flight so as to maintain one of the at least one obstacle sensor in the direction of displacement of the drone.

### CROSS REFERENCE TO RELATED APPLICATIONS

This application claims priority under 35 U.S.C. § 119(a) to French Patent Application Serial Number 1657200, filed Jul. 27, 2016, the entire teachings of which are incorporated herein by reference.

### BACKGROUND OF THE INVENTION

### Field of the Invention

The invention relates to the motorized flying devices such as drones, in particular the rotary-wing drones of the quadricopter type.

### Statement of the Related Art

The AR DRONE 2.0 (™) or the BEBOP DRONE (™) of Parrot SA, Paris, France are typical examples of quadricopters. These quadricopters are equipped with a series of sensors (accelerometers, three-axes gyrometers, altimeter) comprise a camera unit. These drones are provided with several rotors driven by respective motors adapted to be controlled in a differentiated manner in order to pilot the drone in attitude and speed. These drones may comprise at least one video camera unit capturing an image of the scene towards which the drone is directed.

Drones are known, which are equipped with an obstacle detecting and autonomous obstacle avoidance system. For that purpose, the obstacle detection and avoidance system is consisted of two optical sensors positioned on the front face of the drone, the front face being defined by the face of normal direction of forward displacement of the drone. Moreover, the drone includes an image analysis software for detecting obstacles and that immobilizes the drone if it appears that the passage is blocked. If the obstacle can be bypassed, then the drone choses a new path.

However, this drone is only capable of detecting and avoiding an obstacle located in front of the drone front face. Indeed, if the obstacle is at an angle, the system does not allow a good detection of the object. The same is true as regards the obstacles located above or under the drone, these obstacles won't be detected.

These drones may in particular be piloted by a user via a piloting device. Moreover, drones are known, having an autonomous operation mode so that the drone is able to follow a target object to be filmed. The drone following the target object adjusts its position and/or the position of the camera unit so that the target object is always filmed by the drone. The drone being autonomous, i.e. the displacement is calculated by the drone and not piloted by a user, it determines its trajectory as a function of the movements of the target object and controls the camera unit so that the latter is always directed towards the target object to be filmed.

The obstacle detecting system being positioned on the front face of the drone, the latter can hence detect only the obstacles located in the field of view of the optical sensors, i.e. the obstacles located in front of the drone. Hence, in case of implementation of a target object follow-up, the drone is forced to follow the target object by staying behind this object in order to allow an analysis of the front images of the drone.

This solution hence limits the mode of follow-up and capture of a video of the target object. Indeed, the lateral and rearward movements of the drone do not allow the obstacle avoiding.

A solution allowing this problem to be solved consists in equipping the drone with a plurality of obstacle detection and avoidance systems around the drone body in order to allow an analysis for the avoidance of obstacle all around the drone. Such a solution allows a lateral displacement of the drone and a rearward move of the drone. However, this solution has for drawback to be very expensive because it requires the presence of a multitude of obstacle detection and avoidance systems so as to analyse the drone flying environment all around the drone.

### BRIEF SUMMARY OF THE INVENTION

The object of the invention is to remedy these various drawbacks, by proposing a drone provided with at least one obstacle sensor integral with the drone body, said at least one obstacle sensor having a main direction of detection located in a substantially horizontal plane, and with specific means correcting the drone attitude so that the obstacle sensor can always analyse the flying environment in the direction of displacement of the drone and hence avoid the obstacles during the displacement of the drone. Moreover, such an embodiment allows optimizing the number of obstacle sensors on the drone and incidentally the cost of the drone.

For that purpose, the invention proposes a rotary-wing drone comprising a drone body comprising an electronic card controlling the piloting of the drone and a plurality of linking arms, a plurality of propulsion units mounted on respective linking arms, at least one obstacle sensor integral with the drone body, whose main direction of detection is located in a substantially horizontal plane.

Characteristically, the drone includes means for correcting the drone orientation, adapted to correct the yaw orientation of the drone in flight so as to maintain one of said at least one obstacle sensor in the direction of displacement of the drone.

According to various subsidiary characteristics, taken together or in isolation:
the means for correcting the drone orientation include:
means for determining an angular coordinate defined between a direction of displacement of the drone and a direction of the obstacle sensor, and
corrective action means adapted to control the drone in rotation about the yaw axis of said drone, the rotation being function of the angular coordinate determined, allowing the alignment of the obstacle sensor direction with the direction of displacement of the drone.

the corrective action means further include means adapted to act in rotation about the roll axis and/or about the pitch axis in order to maintain the obstacle sensor direction in the direction of displacement of the drone.

the means for determining an angular coordinate include means for detecting the direction of displacement of the drone and means for detecting the obstacle sensor direction.

the means for detecting the direction of displacement of the drone are adapted to determine the angle determining the direction of displacement of the drone ψ_{ref} in the terrestrial reference system (NED) or the angle determining a controlled direction of displacement of the drone ψ_{refcmd} in the terrestrial reference system (NED), said controlled direction being determined from a piloting command received by the drone.

the means for detecting the obstacle sensor direction are adapted to determine the angle determining the obstacle sensor direction ψ in the terrestrial reference system (NED).

the means for determining said angular coordinate include a means for subtracting the angle determining the displacement of the drone or the angle determining the controlled direction of displacement of the drone and the angle determining the obstacle sensor direction.

the drone further includes a mobile support mounted on the drone body comprising a camera adapted to capture a sequence of images and means for inverse correction of the mobile support orientation, adapted to correct the yaw orientation of the support so as to maintain the camera in its sight direction.

the means for inverse correction of the drone orientation include means for acting on the mobile support, adapted to control the mobile support in rotation according to the inverse angular coordinate determined, allowing maintaining the direction of the camera in its sight direction.

The invention also relates to a method of dynamic control of attitude of a rotary-wing drone comprising a drone body, a plurality of linking arms, a plurality of propulsion units mounted on respective linking arms and at least one obstacle sensor integral with the drone body whose main direction of detection is located in a substantially horizontal plane.

Characteristically, when the drone flies, the drone attitude is controlled by the sending of commands of correction of the drone orientation to one or several of said propulsion units to correct the yaw orientation of the drone in flight so as to maintain one of said at least one obstacle sensor in the direction of displacement of the drone.

According to a particular embodiment, the method includes:
a step of determining an angular coordinate defined between a direction of displacement of the drone and a direction of the obstacle sensor, and
a step of sending commands for controlling the drone in rotation about the yaw axis of said drone, the rotation being function of the angular coordinate determined, allowing the alignment of the obstacle sensor direction with the direction of displacement of the drone.

According to another embodiment, the method further includes a step of detecting the direction of displacement of the drone and a step of detecting the obstacle sensor direction.

According to still another embodiment, said angular coordinate is obtained from the direction of displacement of the drone and the obstacle sensor direction.

According to a particular embodiment, the drone further includes a mobile support mounted on the drone body, comprising a camera adapted to capture a sequence of images from the drone, and the method further includes a step of inversely correcting the mobile support orientation to correct the yaw orientation of the support so as to maintain the camera in its sight direction.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an overall view showing the drone according to the invention.

FIGS. 2a, 2b and 2c are views illustrating the correction of the drone orientation according to the invention.

FIG. 3 is a diagram illustrating the determination of an angular coordinate.

FIG. 4 is a detailed view of the means for correcting the drone orientation according to the invention.

FIG. 5 illustrates a flow diagram of correction of the drone orientation according to the invention.

FIG. 6 illustrates another flow diagram of correction of the drone orientation according to the invention.

### DETAILED DESCRIPTION OF THE INVENTION

An exemplary embodiment and implementation of the invention will now be described.

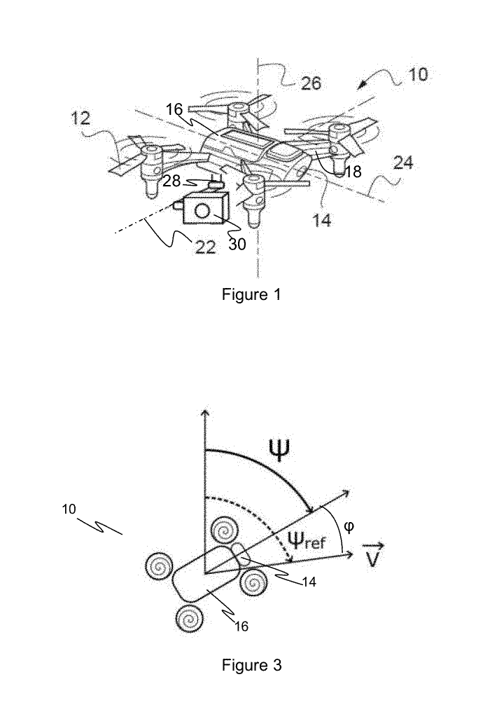

In FIG. 1, the reference 10 generally denotes a drone, that is for example a quadricopter such as the BEBOP DRONE (™) model of Parrot SA, Paris, France. This drone includes a drone body 16 from which radiate four linking arms 18. Four propulsion units 12 of the coplanar rotor type, whose motors are piloted independently from each other by an integrated navigation and attitude control system, are respectively fixed on the four linking arms.

The drone body 16 includes an electronic card controlling the piloting of the drone.

According to the invention, the drone includes for example, on the drone body, at least one obstacle sensor 14 directly or indirectly integral with the drone body, whose main direction of detection is located in a substantially horizontal plane.

According to a particular embodiment, at least one obstacle sensor is positioned on a face of the drone, in particular on a vertical face of the drone, so that the main direction of detection of said at least one obstacle sensor is located in a substantially horizontal plane.

According to another particular embodiment, at least one obstacle sensor is positioned at one end of a support integral with the drone body, located on one face of the drone, for example on the upper face or the lower face of the drone, the position of said at least one obstacle sensor at the end of the support being such that the main direction of detection of said at least one obstacle sensor is located in a substantially horizontal plane.

According to a particular embodiment, illustrated in FIG. 1, the drone includes an obstacle sensor positioned on the front face of the drone body, the front face of the drone body being defined by the main direction of flight of said drone.

According to an embodiment, the drone may include a camera adapted to capture a sequence of images, positioned for example on the front part of the drone.

According to another embodiment, the drone may further include a mobile support 28 mounted on the drone body, comprising a camera 30 adapted to capture a sequence of images.

According to an exemplary embodiment, the drone is provided with inertial sensors (accelerometers and gyrometers) allow measuring with a certain accuracy the angular speeds and the attitude angles of the drone, i.e. the Euler angles (pitch, roll and yaw) describing the inclination of the drone with respect to a horizontal plane of a fixed terrestrial reference system.

According to an embodiment of the invention, the drone 10 is piloted by a remote piloting device provided with a touch screen displaying a certain number of symbols allowing the activation of piloting commands by simple contact of a user's finger on the touch screen.

The touch screen may also display the image captured by the camera of the drone 10, with the command symbols in superimposition.

The piloting device communicates with the drone 10 via a bidirectional exchange of data by wireless link of the Wi-Fi (IEEE 802.11) or Bluetooth (registered trademark) local network type: from the drone 10 to the piloting device, in particular for the transmission of the image captured by the camera, and from the piloting device to the drone 10 for the sending of the piloting commands.

The piloting of the drone 10 consists in making the latter evolve by:
rotation about a pitch axis 22, to make it move forward or rearward; and/or
rotation about a roll axis 24, to move it aside to the right or to the left; and/of
rotation about a heading axis or yaw axis 26, to make the drone main axis, hence the pointing direction of the drone front face, pivot to the right or to the left ; and/or
translation downward or upward by changing the gas control, so as to reduce or increase, respectively, the drone altitude.

According to a particular embodiment, the drone transmits to the piloting device the images captured by the camera equipping the drone, so that these images are displayed on the piloting device. Hence, the drone user may pilot the drone in particular from the images received and hence control the displacement of the drone, based on the images received.

According to another embodiment, it is possible to indicate to the drone a determined target object having to be filmed by the camera on board the drone.

Hence, during the piloting of drone by the user, the drone keeps the camera oriented towards the target object to be filmed or, if the drone includes a mobile camera support 28, the drone controls said mobile support 28 in order to maintain the sight of the camera in the direction of the determined target object to be filmed.

According to another embodiment complementary or alternative to the preceding embodiment, the drone includes a flight mode allowing a follow-up of a determined target object. According to this embodiment, the drone remotely follows the target object and determines the position of the camera in order the latter can keep the target object in sight. In this particular embodiment, the drone user may want to choose following the target objet on the rear, on the front or on one side of the target object, the front, the rear and the side being defined with respect to the direction of displacement of the target object.

In these different embodiments, the camera is adapted to capture a sequence of images of a determined target viewed from the drone. For that purpose, the drone may include means able to adapt the mobile support 28 of the camera in such a manner that the camera 30 captures images of said determined target.

In these different embodiments, the drone must be capable to avoid any obstacle, in order to avoid a fall of the drone, which would be detrimental to it.

For that purpose and according to the invention, the attitude of the drone in flight will be corrected, in particular according the yaw axis, in order to maintain the obstacle sensor 14 fixed directly or indirectly to the drone body, in the direction of displacement of the drone or if the drone includes a plurality of obstacle sensors, to maintain at least one obstacle sensor in the direction of displacement of the drone. Maintaining at least one obstacle sensor in the direction of displacement of the drone allows detecting any obstacle located in the flying environment in the flying direction of the drone and hence incidentally modifying the trajectory of the drone to avoid if an obstacle were to be detected.

According to a particular embodiment, the drone includes a plurality of obstacle sensors, the obstacle sensor maintained in the direction of displacement of the drone detects any obstacle located in the flying environment in the flying direction of the drone and the other obstacle sensors allow detecting the lateral obstacles with respect to the displacement of the drone.

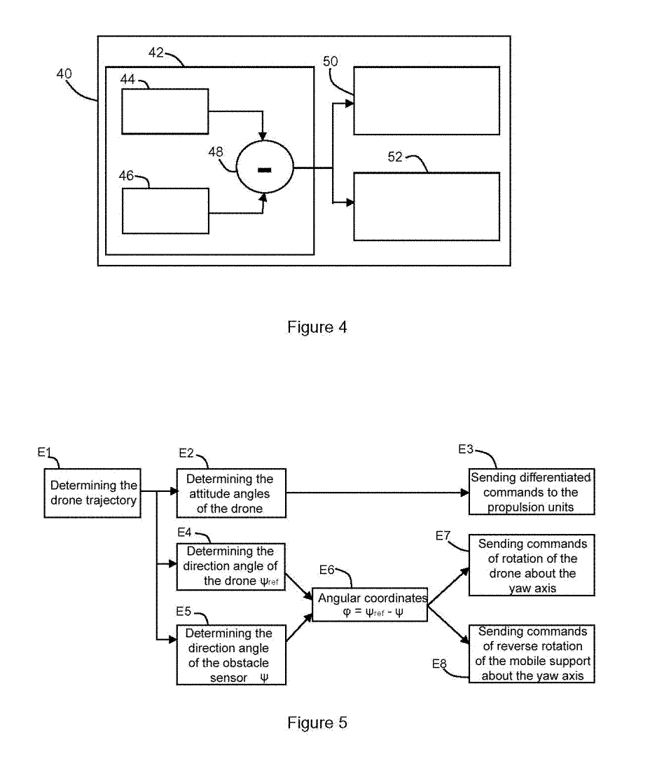

For that purpose, the drone includes means 40 for correcting the drone orientation, adapted to correct the yaw orientation of the drone in flight so as to maintain the obstacle sensor 14 in the direction of displacement of the drone. Said correction means are illustrated in FIG. 4 and will be detailed hereinafter.

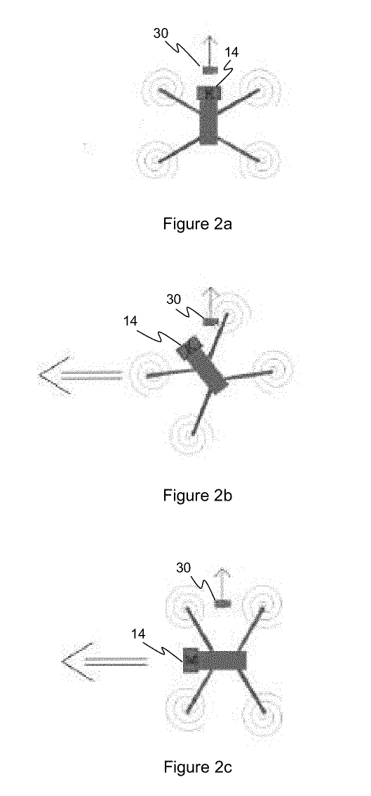

FIGS. 2a, 2b and 2c illustrate the modification of the drone attitude when the drone must be displaced either laterally to the left or rotate to the left about the roll axis.

In particular, FIG. 2a illustrates the position of the drone before the execution of a lateral or roll displacement command, the obstacle sensor located on the front face of the drone body is located in the same direction as the sight of the camera illustrated by an arrow.

As soon as a command of lateral or roll displacement of the drone (represented by the double arrow directed towards the left in FIGS. 2b and 2c) is received, the drone performs a rotation about the yaw axis in order to orient the obstacle sensor positioned on the front face of the drone body in the direction of displacement of the drone. The camera is then maintained, for example, in its initial orientation, so as to maintain the follow-up, for example, of a determined object. Hence, FIG. 2b illustrates the yaw rotation movement of the drone until the front face of the drone body is oriented in the direction of displacement of the drone, as shown in FIG. 2c. The camera sight being kept on the target object, the drone user that will visualize the images captured by the camera won't undergo the rotational movements performed by the drone, in order to orient the obstacle sensor in the direction of displacement of the drone.

This solution hence allows always orienting the or an obstacle sensor in the direction of displacement of the drone and hence allows an analysis of the flying environment of the drone, in particular in the direction of displacement of the drone.

As illustrated in FIG. 3 and in FIG. 4, the yaw correction of the drone performed by the correction means 40 first consists in determining, by determination means 42, an angular coordinate φ of the drone. The latter is defined as being the angle existing between the direction of displacement of the drone ψ_{ref} and the obstacle sensor direction ψ, the different directions being defined in the terrestrial reference system established before the takeoff of the drone, at the time of power on of the drone, according to the classical NED (“North, East, Down”) convention.

According to a particular embodiment, the angular coordinate φ of the drone is defined as being the angle between the controlled direction of displacement of the drone ψ_{refcmd}, this controlled direction being determined from a piloting command received, and the obstacle sensor direction ψ, the directions being defined in the terrestrial reference system.

According to the invention, an angle determining the direction of displacement of the drone ψ_{ref} or the controlled direction of displacement of the drone ψ_{refcmd}, this controlled direction being determined from a piloting command received, and an angle determining the obstacle sensor direction w are determined in the terrestrial reference system according to the NED convention, for example with respect to the North in said reference system, by means 44 for detecting the direction of displacement of the drone and means 46 for detecting the obstacle sensor direction, said detection means being, according to an embodiment, included in the means 42 for determining an angular coordinate of the drone.

According to a particular embodiment of a drone comprising a plurality of obstacle sensors, an angle determining the direction of each obstacle sensor is determined.

According to an embodiment, the means 44 for detecting the direction of displacement of the drone and means 46 for detecting the direction of the obstacle sensor or of each of the obstacle sensors are adapted to determine the angle determining the direction of displacement of the drone and the angle determining the obstacle sensor(s) direction in the terrestrial reference system (NED), for example with respect to the North of said reference system.

According to a particular embodiment, the angular coordinate φ includes the subtraction, performed by a subtraction means 48, of the angle determining the direction of displacement of the drone ψ_{ref} and of the angle determining the obstacle sensor direction ψ.

According to the embodiment in which the drone includes a plurality of obstacle sensors, the angular coordinate φ includes the smallest value of subtraction in absolute value among the whole subtractions made by said subtraction means 48 of the angle determining the direction of displacement of the drone ψ_{ref} with respectively each angle determining the direction of an obstacle sensor.

The drone further includes corrective action means 50 adapted to control the drone in rotation about the yaw axis of said drone, the rotation being function of the angular coordinate φ determined, allowing the alignment of the obstacle sensor direction with the direction of displacement of the drone.

For that purpose, the integrated navigation and attitude control system of the drone will generate one or several differentiated commands from the angular coordinate φ determined and will send them to one or several propulsion units 12 of the drone so as to produce the rotation of the drone.

The sending of one or several differentiated commands includes for example the generation of yaw angle set-point value and the application of these set-point values to a feedback loop for controlling the drone motors.

According to a particular embodiment, the corrective action means 50 are adapted to control the drone in rotation about the yaw axis of said drone and to control the drone in rotation about the pitch and/or roll axis.

Moreover, according to a particular embodiment, the drone includes means 52 for the inverse correction of the orientation of the mobile support 28 that are adapted to correct the yaw orientation of the mobile support 28 so as to maintain the camera in its direction before performing the corrective actions on said drone.

Indeed, the invention consists in correcting during the flight the sight direction of said at least one obstacle sensor by a rotation of the drone so that the sight direction of the obstacle sensor is always in the direction of displacement of the drone. It is important in this context to correct the mobile support 28 of the camera so as not to pass on the correction operated on the drone to the mobile support but, on the contrary, to have a correction that is substantially inverse of that of the camera support so that the camera 30 keeps its sight, for example, on the target object to be filmed.

For that purpose, the means 52 for inversely correcting the drone orientation include means for acting on the mobile support, adapted to control the mobile support 28 in rotation according to the inverse angular coordinate (−φ) determined, allowing maintaining the direction of the camera 30 in its sight direction, i.e. the direction before the corrective actions performed on said drone.

We will now describe the different steps of the method implemented in the drone for dynamically controlling the attitude of the drone and in particular determining the differentiated commands to be sent to one or several propulsion units 12 of the drone in order to maintain the obstacle sensor of said drone in the direction of displacement of the drone.

The method of dynamic control is illustrated in FIG. 5.

The method includes a step E1 of determining the drone trajectory. According to the navigation mode of the drone, the trajectory is determined either as a function of the commands received from the user or as a function of the movements of the target object to be followed.

Step E1 is followed by step E2 of determining the drone attitude angles to be modified in order to follow the trajectory determined and generating drone rotation angle set-point values according to the different drone attitude angles determined.

Step E2 is followed by step E3 of sending one or several differentiated commands determined as a function of the determined attitude angles to one or several of said propulsion units 12 of the drone to control the attitude of said drone.

Step E3 of sending one or several differentiated commands includes for example generating angle set-point values and applying these set-point values to a feedback loop for controlling the drone motors.

Step E1 is also followed by step E4, which may be executed in parallel to step E2 of determining the direction of displacement of the drone based on the trajectory determined. During this step, the angle determining the displacement of the drone ψ_{ref} in the terrestrial reference system (NED) is determined.

Step E1 may also be followed by step E5, which may be executed in parallel to step E2 and/or to step E4, of determining the obstacle sensor direction. During this step, the angle determining the obstacle sensor direction ψ in the terrestrial reference system (NED) is determined.

Steps E4 and E5 are followed by a step E6 of determining an angular coordinate φ defined between the direction of displacement of the drone and the obstacle sensor direction. For that purpose, the angular coordinate φ is determined by subtracting from the angle determining the direction of displacement of the drone ψ_{ref}, the angle determining the obstacle sensor direction ψ. Indeed, the angular coordinate φ is defined as follows:

φ=ψ_{ref}−ψ

Step E6 is followed by a step E7 of sending differentiated commands determined as a function of the angular coordinate φ determined to one or several of said propulsions units 12 of the drone to modify the rotation about the yaw axis of said drone and hence to allow a rotation of the drone so as to maintain the obstacle sensor in the direction of displacement of the drone.

Step E7 of sending one or several differentiated commands includes for example generating yaw angle set-point values and applying these set-point values to a feedback loop for controlling the drone motors.

According to an embodiment in which the drone includes a mobile support 28 mounted on the drone body 16 comprising a camera 30, the method further includes a step E8 that follows step E6, of sending correction commands that are inverse to those of the drone to said mobile support 28 so as not to cause a rotation of the image sighted by the camera 30. Indeed, during this step, the drone performs a yaw rotation by a determined angle φ and the mobile support must perform a rotation in the reverse direction, i.e. −φ, in order to maintain the camera in its sight direction.

The commands of correction of the yaw rotation of the drone and the command of inverse correction of the yaw rotation of the mobile support must be performed in a synchronous manner so as to maintain the camera in its sight direction, in particular in order to avoid any non-desired movement in the succession of images forming the film of the target.

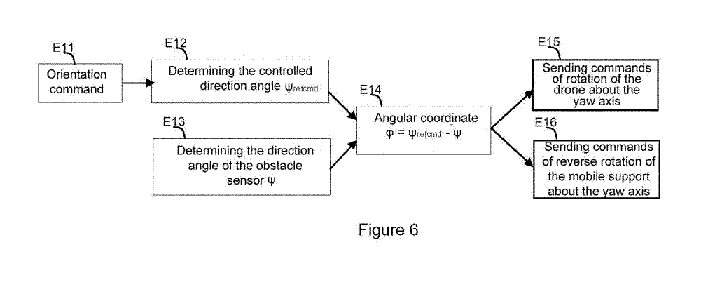

According to another embodiment of the method of dynamic control illustrated in FIG. 6, said method performs a correction of the drone direction as soon as a piloting command is received, and based on the information contained in said piloting command (and not based on the determined trajectory of the drone), i.e. the information of attitude change, in particular the indication of a rotation about the roll axis or a controlled lateral displacement.

Said method includes a step E11 of receiving a piloting command in order to modify the attitude of the drone.

Step E11 is followed by step E12 of determining the controlled angle of direction of displacement of the drone, this controlled direction being determined from the piloting command received. During this step, the angle determining the controlled direction of displacement of the drone ψ_{refcmd} in the terrestrial reference system (NED) is determined.

Step E11 may also be followed by step E13, that may be executed in parallel to step E12, of determining the obstacle sensor direction. During this step, the angle determining the obstacle sensor direction φ in the terrestrial reference system (NED) is determined.

Steps E12 and E13 are followed by a step E14 of determining an angular coordinate φ defined between the controlled direction of displacement of the drone and the obstacle sensor direction. For that purpose, the angular coordinate φ is determined by subtracting from the angle determining the controlled direction of displacement of the drone ψ_{refcmd}, the angle determining the obstacle sensor direction ψ. Indeed, the angular coordinate φ is defined as follows:

φ=ψ_{refcmd}−ψ

Step E14 is followed by a step E15 of sending differentiated commands determined as a function of the angular coordinate φ determined to one or several of said propulsion units 12 of the drone to modify the rotation about the yaw axis of said drone and hence to allow a rotation of the drone so as to maintain the obstacle sensor in the direction of displacement of the drone.

Step E15 of sending one or several differentiated commands includes for example generating yaw angle set-point values and applying these set-point values to a feedback loop for controlling the drone motors.

According to an embodiment in which the drone includes a mobile support 28 mounted on the drone body 16 comprising a camera 30, the method further includes a step E16 that follows step E14, of sending correction commands that are inverse to those of the drone to said mobile support 28 so as not to cause a rotation of the image sighted by the camera 30. Indeed, during this step, the drone performs a yaw rotation by a determined angle φ and the mobile support must perform a rotation in the reverse direction, i.e. −φ, in order to maintain the camera in its sight direction.

The commands of correction of the yaw rotation of the drone and the command of inverse correction of the yaw rotation of the mobile support must be performed in a synchronous manner so as to maintain the camera in its sight direction, in particular in order to avoid any non-desired movement in the succession of images forming the film of the target.

What is claimed is:

1. A rotary-wing drone comprising
a drone body comprising an electronic card comprising memory and at least one processor with programmatic code executing therein to control piloting of the drone and a plurality of linking arms,
a plurality of propulsion units mounted on respective linking arms,
at least one obstacle sensor integral with the drone body, whose main direction of detection is located in a substantially horizontal plane,
wherein the drone comprises correction logic executing in the memory of the electronic code, the logic correcting the drone orientation, including correcting the yaw orientation of the drone in flight so as to maintain one of said at least one obstacle sensor in a direction of displacement of the drone.

2. The drone according to claim 1, the logic during execution in the memory of the card performs:
determining an angular coordinate defined between the direction of displacement of the drone and a direction of the obstacle sensor, and
controlling the drone in rotation about the yaw axis of said drone, the rotation being function of the angular coordinate determined, allowing the alignment of the obstacle sensor direction with the direction of displacement of the drone.

3. The drone according to the claim 2, wherein the logic during execution in the memory of the card further performing a rotation about either or both of a roll axis and a pitch axis in order to maintain the obstacle sensor direction in the direction of displacement of the drone.

4. The drone according to claim 2, wherein the determining of an angular coordinate comprises detecting a direction of displacement of the drone and detecting the obstacle sensor direction.

5. The drone according to claim 4, wherein the detecting of the direction of displacement of the drone includes determining the angle by determining the direction of displacement of the drone ψ_{ref} in the terrestrial reference system (NED) or the angle determining a controlled direction of displacement of the drone ψ_{refcmd} in the terrestrial reference system (NED), said controlled direction being determined from a piloting command received by the drone.

6. The drone according to claims 4, wherein the detecting of the obstacle sensor direction comprises determining the angle determining the obstacle sensor direction ψ in the terrestrial reference system (NED).

7. The drone according to claim 5, wherein the determining of said angular coordinate comprise subtracting the angle determining the displacement of the drone or the angle determining the controlled direction of displacement of the drone and the angle determining the obstacle sensor direction.

8. The drone according to claim 1, wherein the drone further comprise a mobile support mounted on the drone body comprising a camera adapted to capture a sequence of images and inverse correction logic adapted to correct the mobile support orientation by correcting the yaw orientation of the support so as to maintain the camera in its sight direction.

9. The drone according to claim 8, characterized in that the inverse correction logic is further enabled to control the mobile support in rotation according to the inverse angular coordinate determined, allowing maintaining the direction of the camera in its sight direction

10. A method of dynamic control of attitude of a rotary-wing drone comprising a drone body, a plurality of linking arms, a plurality of propulsion units mounted on respective linking arms and at least one obstacle sensor integral with the drone body, whose main direction of detection is located in a substantially horizontal plane, the method comprising:
controlling drone attitude of the drone when the drone flies by sending of correction of the drone orientation to one or several of said propulsion units to correct the yaw orientation of the drone in flight so as to maintain one of said at least one obstacle sensor in the direction of displacement of the drone.

11. The dynamic control method according to claim 10, wherein the controlling comprises:
determining an angular coordinate defined between a direction of displacement of the drone and a direction of the obstacle sensor, and
sending commands for controlling the drone in rotation about the yaw axis of said drone, the rotation being function of the angular coordinate determined, allowing the alignment of the obstacle sensor direction with the direction of displacement of the drone.

12. The dynamic control method according to claim 11, wherein the controlling further comprises a step of detecting the direction of displacement of the drone and a step of detecting the obstacle sensor direction.

13. The dynamic control method according to claim 12, wherein said angular coordinate is obtained from the direction of displacement of the drone and the obstacle sensor direction.

14. The dynamic control method according claim 12, wherein the drone further comprises a mobile support mounted on the drone body, comprising a camera adapted to capture a sequence of images from the drone, and the method further comprises a step of inversely correcting the mobile support orientation to correct the yaw orientation of the support so as to maintain the camera in its sight direction.
